(19) United States
(12) Patent Application Publication
(10) Pub. No.: US 2025/0273226 A1
(43) Pub. Date: Aug. 28, 2025

(54) PCEN-BASED MASK THRESHOLDING AND VOICE ACTIVITY DETECTION FOR TRAINING DNN-BASED SPEECH ENHANCEMENT MODELS

(71) Applicant: DOLBY LABORATORIES LICENSING CORPORATION, San Francisco, CA (US)

(72) Inventors: Xiaoyu Liu, Dublin, CA (US); Roy M. Fejgin, San Francisco, CA (US); Cong Zhou, Foster City, CA (US); Kai Li, Beijing (CN)

(73) Assignee: DOLBY LABORATORIES LICENSING CORPORATION, San Francisco, CA (US)

(21) Appl. No.: 18/857,711

(22) PCT Filed: Apr. 19, 2023
(86) PCT No.: PCT/US2023/019105

§ 371 Date: Oct. 17, 2024

Related U.S. Application Data
(60) Provisional application No. 63/493,979, filed on Apr. 3, 2023.
(60) Provisional application No. 63/437,273, filed on Jan. 5, 2023.

(30) Foreign Application Priority Data
Apr. 20, 2022 (WO) PCT/CN2022/087983

(51) Int. Cl. G10L 21/0224; G10L 25/21; G10L 25/30; G10L 25/84; G10L 25/93

(52) U.S. Cl. CPC G10L 21/0224; G10L 25/21; G10L 25/30; G10L 25/84; G10L 25/93; G10L 2025/937

(57) ABSTRACT

Described herein is a method of determining at least one mask for use in training a deep neural network (DNN)—based mask-based audio processing model. In particular, the method may comprise obtaining a time-frequency representation of a target audio signal for use in the training. The method may further comprise determining a per-channel energy normalization (PCEN) measure for the target audio signal. The method may yet further comprise determining the at least one mask based on the PCEN measure.

### CROSS-REFERENCE TO RELATED APPLICATION

This application claims the priority of the following priority applications: U.S. Provisional Application No. 63/493,979, filed Apr. 3, 2023, U.S. Provisional Application No. 63/437,273, filed Jan. 5, 2023, and International Application No. PCT/CN2022/087983 filed Apr. 20, 2022, each of which is hereby incorporated by reference in its entirety.

### TECHNICAL FIELD

The present disclosure is directed to the general area of audio processing, and more particularly, to speech enhancement using a neural network.

### BACKGROUND

Generally speaking, speech enhancement related processes typically target removing one or more unwanted artifacts from a noisy waveform and preserving clean speech. Recently, such speech enhancement processes tend to also take advantage of machine learning based techniques, such as deep neural networks (DNN), or the like.

In a broad sense, in an exemplary DNN-based system, a noisy waveform, which might be a mixture of clean speech, noise, echo, reverberation, etc., as well as a far-end echo reference signal or the like, may be processed by spectral transform and (optionally) banding. Subsequently, a DNN may take the mixture band energy as input and attempt to predict a mask for each time-frequency band. The mask value is usually between 0 and 1, which generally represents the (estimated/predicted) degree of speech present in the mixture. During training, the DNN may be exposed to a large dataset of mixtures that may be, for example, manually created by randomly adding all the signal components, or the like. In some possible implementations, for each sample, an ideal mask might be defined, such as an ideal ratio mask (IRM), according to:

IRM(t,f)=S(t,f)/S(t,f)+N(t,f)+E(t,f) (1)

where S(t, f), N(t, f) and E(t, f) are generally the time-frequency band energy of the clean speech, noise and echo, respectively. Then, the DNN weights would be updated towards minimizing a loss function that generally measures the difference between the predicted and the ideal masks, as may be understood and appreciated by the skilled person.

However, there may exist several issues with the above ideal mask-based technique. First, it may be generally challenging to collect a large amount of studio-quality clean speech signals. Quite often, the “clean” signals may come with some degree of stationary noise (before adding additional noise in training for example for the de-noising task), such as recording noise, room noise, etc. Therefore, IRM is usually larger than it should be, and models trained with such IRM typically cannot remove the associated stationary noise. Moreover, in a clean speech signal, there may exist some time-frequency bands whose energy is relatively small (e.g., below a certain threshold). Omitting these bands may not be perceptually noticeable. However, an algorithm would be needed to carefully pick a threshold in order to avoid zeroing meaningful speech. In addition, in some possible cases, a speech enhancement DNN may also need to learn (at least implicitly) a behavior of a voice actively detector (VAD), for example in order to be able to preserve speech and remove noise in a speech region, while to (aggressively) remove unwanted artifacts in a non-speech region.

In view of some or all of the above-illustrated issues, generally speaking, there appears to exist a need for techniques and/or mechanisms of performing mask thresholding and/or voice activity detection for training DNN-based speech enhancement models.

### SUMMARY

In view of the above, the present disclosure generally provides a method of determining at least one mask for use in training a deep neural network (DNN)-based mask-based audio processing model, a method of determining a speech-aware loss function for use in training a DNN-based audio processing model, a method of training a DNN-based audio processing model, a method of classifying a target audio signal into speech frames or non-speech frames, a corresponding apparatus, a program, as well as a computer-readable storage media, having the features of the respective independent claims.

According to a first aspect of the present disclosure, a method of determining at least one mask (e.g., one or more masks) for use in training a DNN-based mask-based audio processing model is provided. The model may be trained for performing any suitable audio related processing, such as (but is certainly not limited to) speech enhancement (e.g., de-nosing, removing artifacts, etc.), or the like. As can also be understood and appreciated by the skilled person, any suitable DNN (or more generally, any suitable neural network) implementation may be used, regardless of the actual architecture, depending on various implementations and/or applications.

In particular, the method may comprise obtaining a time-frequency representation of a target audio signal for use in the training. In general, particularly within the technical context of the present disclosure, the term “target audio signal” is typically used to refer to the audio signal that the DNN-based model is trained for, in order to perform the respective audio processing, unless indicated otherwise. As an illustrative (non-limiting) example for ease of understanding, in some cases where the model is trained for preserving only clean audio signals from a noisy audio mixture (e.g., by removing all unwanted artifacts), the target audio signal may then be clean audio (e.g., speech) signals (e.g., collected by professionals). In some other cases where the model is trained for not removing reverberation (but removing all other artifacts) from a noisy audio mixture, the target audio signal may then be reverberant audio signals (i.e., with reverberation). Thus, in some possible cases, such target audio signal may also be understood to represent a ground truth for the training.

The method may further comprise determining a per-channel energy normalization (PCEN) measure for the target audio signal. As will be discussed in more detail below, PCEN may be seen as an audio signal processing technique to normalize the energy of each frequency channel in a spectrogram. In a broad sense, the PCEN-based technique may seek to normalize the energy of each frequency channel in the spectrogram by dividing it by a quantity that is proportional to the average energy of that channel over time. This helps to reduce the effects of background noise and variations in the signal level across different frequency channels.

Accordingly, the method may yet comprise determining the at least one mask based on the PCEN measure.

Configured as proposed above, the proposed method may generally provide an efficient, flexible yet reliable mechanism for determining the mask that may be later used in training the DNN-based audio processing (e.g., speech enhancement) model. Specifically, as noted above, “clean” speech signals collected for training (e.g., S(t, f) in the above equation (1)) often come with some degree of stationary noises, which might cause failure for a DNN trained with conventional IRMs to be able to successfully and fully remove such stationary noises. Now, particularly by the introduction of the PCEN measure in the process as proposed above, the mask(s) may be determined in such a manner that also those stationary noises (which are typically embedded in the “clean” signals) could be largely (or even completely in some cases) removed, thereby significantly improving the performance of the subsequent training process, and in turn, also significantly improving the final performance in real practice (i.e., after the model has been trained). Incidentally, it is also to be noted that, compared to conventional techniques, the PCEN measure as proposed in the present disclosure is generally used only in the training stage but not at testing time.

In some example implementations, the target audio signal may comprise speech and/or music. As noted above, as can be understood and appreciated by the skilled person, the target audio signal may comprise any other suitable form of audio signal, depending on various implementations and/or applications.

In some example implementations, the target audio signal may be for use as a ground truth for the training.

In some example implementations, the target audio signal may comprise a clean audio component, and a stationary noise component such as recording noise and/or room noise. As indicated above, in some possible cases, for example during studio production, the obtained “clean” signals may (sometimes unavoidably) comprise some degree of stationary noises, which may include (but is certainly not limited thereto) recoding noises (e.g., mechanical noises of the recording devices), (background) room noise (e.g., air flow sounds, or the like). It is nevertheless worth mentioning that, as can also be understood and appreciated by the skilled person, particularly within the technical context of the present disclosure, such stationary noise should be differentiated from those (e.g., man-made/artificially-generated) noises that may have been specifically or even intentionally inserted or added to the “clean” signals for purposes (e.g., denoising) of the training. Moreover, it may be worthwhile to emphasize again that the training process per se is generally for removing those man-made/artificially-generated noises (where the “clean” audio signals are used as the ground truth); while on the other hand, the techniques as proposed in the present disclosure are generally for removing the impact or influence of those stationary noises (which may already exist in those “clean” audio signals being used as the ground truth for the training), thereby improving the performance of the overall training.

In some example implementations, the PCEN measure may be determined based on a ratio of a time-frequency energy measure of the target audio signal and a running average of the time-frequency energy measure of the target audio signal. As can be understood and appreciated by the skilled person, similar to the case of time-frequency representation, also here any suitable time-frequency energy measure may be used, depending on various implementations and/or circumstances. For instance, in some possible cases, the time-frequency energy measure may be implemented as band energy. In some other possible cases for example when banding is not used, the time-frequency energy measure may for example be implemented using bin energy instead. Of course, this generality applies to any suitable transform (such as Fast Fourier Transform (FFT), Modulated Discrete Transform (MDXT), Complex Quadrature Mirror Filter (CQMF), or the like) and/or banding types.

In some example implementations, the method may further comprise obtaining an audio mixture (or sometimes also referred to as an audio mix) based on the target audio signal. In particular, the audio mixture may comprise, in addition to the target audio signal, audio artifacts (e.g., noise, (far-end) echo, reverberation, or the like). Depending on various circumstances, the audio mixture may be pre-collected (e.g., from one or more available databases) or be generated (e.g., manually or automatically). As can be understood and appreciated by the skilled person, the audio mixture may be generated so as to fit the respective training purpose (corresponding to the respective audio processing aspect). As an illustrative (non-limiting) example, in cases where the training is for removing noises (denoising), the audio mixture may be so generated to include various suitable (e.g., artificially generated) noises. Similarly, as another illustrative (non-limiting) example, in cases where the training is for removing reverberation, the audio mixture may be so generated to include various suitable (e.g., artificially generated) reverberations. More particularly, the determination of the at least one mask based on the PCEN measure may involve determining at least one ideal ratio mask (IRM) measure based on the target audio signal and the audio mixture; and adjusting the at least one IRM measure to obtain the at least one mask based on the PCEN measure. Put differently, it may be understood that the proposed techniques of the present disclosure may take the IRM measure as a starting point and, by suitably and appropriately adjusting the IRM measure based on the PCEN measure (which, among others, reduces or eliminates the impact of possible stationary noises hidden in the clean ground truth audio signals), arrive at the final mask that could be used for the subsequent training process. The IRM measure may be determined according to the above-mentioned equation (1) or by using any other suitable implementation, as can be understood and appreciated by the skilled person.

In some example implementations, the audio artifacts may comprise at least one of: noise, echo, or reverberation. As noted above, this artifact-like noise is to be differentiated from the above stationary noise(s) possibly hidden in the clean ground truth audio signals. Of course, any other suitable audio artifact may be considered as well for the purpose of training, as can be understood and appreciated by the skilled person.

In some example implementations, the IRM measure may be determined as a ratio of a time-frequency energy measure of the target audio signal to a time-frequency energy measure of the audio mixture including the audio artifacts, such as according to the above-defined equation (1). As illustrated above, any suitable implementation for the time-frequency energy measure may be considered for such calculation. Of course, any other suitable determination (calculation) may be adopted as well, depending on various implementations and/or applications.

In some example implementations, respective values of the PCEN and the IRM measures may be determined for each time-frequency band of the target audio signal. Accordingly, the adjustment of the IRM measure may involve: for each time-frequency band, setting the respective IRM measure value for that time-frequency band to 0, if the respective PCEN measure value is less than a first predetermined (or preconfigured) threshold (e.g., 10⁻⁵). Particularly, by setting the IRM measures of the bands with stationary noise to 0, the model may be trained to be able to learn to fully remove such (stationary) noise (which may be otherwise difficult to identify and/or remove). Moreover, omitting the small-energy speech bands by setting their IRM measures to 0 may reduce the variability of the training targets, and possibly also enable the model to focus on meaningful speech bands. More specifically, since the PCEN measure is considered to generally represent a smoothed version of the target signal, the energy dynamic range after PCEN would be relatively narrower (in comparison with techniques without PCEN). Therefore, a global constant may be suitably determined to act as the threshold. For instance, in some possible (non-limiting) implementations, this threshold may be obtained by generating a histogram of many PCEN-processed speech band energies and picking a small boundary value that won't zero out (meaningful) speech.

In some example implementations, the method may further comprise classifying the target audio signal into speech frames or non-speech frames. Accordingly, the method may also comprise, for each audio frame, determining the at least one mask further based on the classification of speech frames or non-speech frames.

In some example implementations, the classification of the target audio signal into speech frames or non-speech frames may involve, for each audio frame of the target audio signal: determining a respective frame-wise PCEN measure across all frequency bands of that audio frame; and if the determined frame-wise PCEN measure is larger than a second predetermined threshold, classifying that audio frame into a speech frame; otherwise, classifying that audio frame into a non-speech frame. As can be understood and appreciated by the skilled person, the (earlier-mentioned) PCEN measure and the frame-wise PCEN measure and/or the first and second predetermined thresholds may, but certainly do not necessarily have to, be the same or calculated differently. In some possible implementations, the second predetermined threshold may be determined empirically as the first predetermined threshold multiplied by a number (e.g., average) of bands in a frame.

In some example implementations, the determination of the at least one mask further based on the classification of speech frames or non-speech frames may involve setting the respective IRM measure values for all non-speech frames to 0. In other words, if the frame energy falls below the second threshold, this frame may be classified as a non-speech frame, and as a result, the respective IRM values of all the bands in that frame may be set to 0, which may help to further reduce the variability in the training targets.

In some example implementations, the PCEN measure may be determined according to, for each time-frequency band:

$$PCEN ( t , f ) = {( \frac{S ( t , f )}{{( ε + M ( t , f ) )}^{α}} + δ )}^{r} - {δ}^{r} ,$$

wherein S(t, f) is a time-frequency energy of the target audio signal, ε, α, δ, and r are predetermined constants, and M(t, f) is a running average of S(t, f) defined as:

$$M ( t , f ) = ( 1 - s ) \cdot M ( t - 1 , f ) + s \cdot S ( t , f ) ,$$

in which s is a predetermined smoothing factor. It is to be noted that this calculation is merely given as an illustrative example, and should not be understood as a limitation of any kind. Of course, as can be understood and appreciated by the skilled person, any other suitable determination or calculation for the PCEN measure may be used as well, depending on various implementations and/or applications.

In some example implementations, the DNN-based mask-based audio processing model may be a multitask model configured for being trained for predicting a plurality of masks each corresponding to a respective audio processing aspect. That is to say, in some possible implementations, a DNN-based model may be trained to predict K sets of marks. As an illustrative example, one mask could be defined to remove any artifacts (such as noise, reverberation, echo, or the like), while a second mask may be trained to not remove reverberation (but all other artifacts), and finally, a third mask may target at preserving music and speech. Accordingly, the method may involve steps of: obtaining a respective target audio signal for each audio processing aspect; determining a respective PCEN measure for each target audio signal; and determining a respective mask based on the PCEN measure. It is nevertheless to be noted that, in a broad sense, one or more PCEN-based thresholds as illustrated above might be applied to one or more sets of masks. In other words, some of the masks may (but do not necessarily have to) use the proposed PCEN-based techniques, while some others do not.

According to a second aspect of the present invention, a method of determining a speech-aware loss function for use in training a DNN-based mask-based audio processing model is provided. The model may be trained for performing any suitable audio related processing, such as (but is certainly not limited to) speech enhancement (e.g., denoising, removing artifacts, etc.), or the like. As can also be understood and appreciated by the skilled person, any suitable DNN (or more generally, neural network) implementation may be used, regardless of the actual architecture, depending on various implementations and/or applications.

In particular, the method may comprise obtaining a time-frequency representation of a target audio signal for use in the training. In general, particularly within the technical context of the present disclosure, the term “target audio signal” is typically used to refer to the audio signal that the DNN-based model is trained for, in order to perform the respective audio processing, unless indicated otherwise. As an illustrative (non-limiting) example for ease of understanding, in some cases where the model is trained for preserving only clean audio signals from a noisy audio mixture (e.g., by removing all unwanted artifacts), the target audio signal may then be clean audio (e.g., speech) signals (e.g., collected by professionals). In some other cases where the model is trained for not removing reverberation (but removing all other artifacts) from a noisy audio mixture, the target audio signal may then be reverberant audio signals (i.e., with reverberation).

The method may further comprise determining presence of speech in the audio signal by using a voice activity detection (VAD) process. As may be understood and appreciated by the skilled person, any suitable (existing or new) VAD technique may be used. An illustrative (non-limiting) example of an existing VAD technique may be the conventional WebRTC VAD technique.

The method may yet comprise determining the loss function based on the determined presence of speech in the target audio signal. Particularly, as can be understood and appreciated by the skilled person, gradient descent is typically used to minimize the loss by back propagating this gradient through all the model weights. Accordingly, the determination of the loss function may be achieved by controlling gradient of the loss function based on the determined presence of speech in the target audio signal.

In some example implementations, the VAD process may involve determining frame-wise and/or band-wise presence of speech in the target audio signal. In addition, the controlling of the gradient of the loss function based on the determined presence of speech in the target audio signal may involve increasing the respective gradient of the loss function for a non-speech frame and/or band such that audio artifacts are suppressed more aggressively in the non-speech frame and/or band. That is to say, in some possible implementations, the gradient may be controlled in such a way that the predicted masks could be driven aggressively towards 0 in order to remove unwanted artifacts in the non-speech frames.

Configured as proposed above, the proposed method may generally provide an efficient, flexible yet reliable mechanism for determining the loss function that may be later used in training the DNN-based audio processing (e.g., speech enhancement) model. Specifically, according to the techniques proposed above, the loss function may be determined in such a manner that is designed to assign a higher priority to preserving speech than removing noise (in speech frames); whereas in non-speech frames, noise (and other unwanted artifacts, such as echo or the like) might be suppressed as aggressively as possible. Thereby, the performance of the training process may be significantly improved, and in turn, the final performance in real practice (i.e., after the model has been trained) may also be significantly improved.

In some example implementations, the determination of the frame-wise presence of speech in the target audio signal involves, for each audio frame of the target audio signal: determining a frame-wise per-channel energy normalization (PCEN) measure across all frequency bands of the respective audio frame; and if the determined frame-wise PCEN measure is larger than a predetermined threshold, determining that the respective audio frame contains speech. The frame-wise PCEN may be determined (e.g., calculated) in any suitable manner, e.g., similar to or different from those illustrated above with respect to the first aspect of the present disclosure.

In some example implementations, the determination of the band-wise presence of speech in the audio signal may involve, for each speech frame of the target audio signal: determining a respective band-wise PCEN measure for each frequency band of that speech frame; and if the determined band-wise PCEN measure is less than a second predetermined threshold, determining the respective frequency band of that speech frame as a non-speech band. Similar to above, the band-wise PCEN measure may be determined or calculated in the same manner as, or different from, those illustrated above with respect to the first aspect of the present disclosure.

In some example implementations, the loss function may be determined such that over-suppression of speech is penalized more than under-suppression of noise in the target audio signal. Generally speaking, one of the main reasons is that a (speech enhancement related) DNN is typically trained to, in a speech region, preserve speech and remove noise (usually with the bias towards preserving speech), whilst in a non-speech region, aggressively remove unwanted artifacts (with no concern of over-suppressing speech).

In some example implementations, the loss function loss may be defined as, for each time-frequency band:

$$loss = {a}^{diff} - d i f f - 1 ,$$

where α is a predetermined constant, and diff indicates a difference between an ideal ratio mask (IRM) measure determined for the target audio signal and an estimated mask maskₑₛₜ predicted by the DNN-based audio processing model. Of course, as can be understood and appreciated by the skilled person, any suitable loss function may be determined/designed, depending on various implementations and/or applications.

In some example implementations, the diff may be defined as, for a speech frame:

$$d iff = {IRM}^{γ} - {mask}_{e s t}^{γ}$$

and for a non-speech frame:

diff=maskₑₛₜ^{γ},

in which γ is a predetermined constant. As noted above, any other suitable determination or calculation may be adopted as well, depending on various implementations and/or applications.

In some example implementations, the IRM measure may be the mask determined by using the method according to any one of the example implementations as proposed with respect to the first aspect of the present disclosure.

In some example implementations, the determination of the loss function may involve: determining respective loss functions for speech and non-speech frames; and averaging the loss functions for all time-frequency bands, thereby obtaining a final loss function. Of course, as noted above, any other suitable ways for determining or calculating the loss function may be adopted, depending on various implementations and/or applications.

According to a third aspect of the present invention, a method of training a deep neural network (DNN)-based audio processing model is provided. In particular, the DNN-based audio processing model may be trained based on the mask determined by using the method according to any one of the example implementations as proposed with respect to the first aspect of the present disclosure and/or the (speech-aware) loss function determined by using the method according to any one of the example implementations as proposed with respect to the second aspect of the present disclosure.

According to a fourth aspect of the present invention, a method of classifying a target audio signal into speech frames or non-speech frames is provided. In particular, the method may comprise, for each audio frame of the target audio signal: determining a respective frame-wise per-channel energy normalization (PCEN) measure across all frequency bands of that audio frame; and if the determined frame-wise PCEN measure is larger than a predetermined threshold, classifying that audio frame into a speech frame; otherwise, classifying that audio frame into a non-speech frame.

According to a fifth aspect of the present invention, an apparatus including a processor and a memory coupled to the processor is provided. The processor may be adapted to cause the apparatus to carry out all steps according to any of the example methods and the example implementations thereof described in the foregoing aspects.

According to a sixth aspect of the present invention, a computer program is provided. The computer program may include instructions that, when executed by a processor, cause the processor to carry out all steps of the example methods described throughout the present disclosure.

According to a seventh aspect of the present invention, a computer-readable storage medium is provided. The computer-readable storage medium may store the aforementioned computer program.

It will be appreciated that apparatus features and method steps may be interchanged in many ways. In particular, the details of the disclosed method(s) can be realized by the corresponding apparatus (or system), and vice versa, as the skilled person will appreciate. Moreover, any of the above statements made with respect to the method(s) are understood to likewise apply to the corresponding apparatus (or system), and vice versa.

### BRIEF DESCRIPTION OF DRAWINGS

Example embodiments of the present disclosure are explained below with reference to the accompanying drawings, wherein like reference numbers indicate like or similar elements, and wherein

FIG. 1 is a schematic illustration showing a diagram of an example deep neural network (DNN)-based audio processing system,

FIG. 2 is a schematic illustration showing a comparison between an example band energy and its per-channel energy normalization (PCEN)-based version of a speech signal with stationary noise,

FIG. 3 is a schematic illustration showing an example of a loss function implementation according to embodiments of the present disclosure,

FIG. 4 is a schematic illustration showing another example of a loss function implementation according to embodiments of the present disclosure,

FIG. 5 is a schematic illustration showing a diagram of an example DNN configured for training multitask models according to embodiments of the present disclosure,

FIG. 6 is a schematic flowchart illustrating an example of a method of determining at least one mask for use in training a DNN-based mask-based audio processing model according to embodiments of the present disclosure,

FIG. 7 is a schematic flowchart illustrating an example of a method of determining a speech-aware loss function for use in training a DNN-based audio processing model according to embodiments of the present disclosure,

FIG. 8 is a schematic flowchart illustrating an example of a method of classifying a target audio signal into speech frames or non-speech frames according to embodiments of the present disclosure, and

FIG. 9 is a schematic block diagram of an example apparatus for performing methods according to embodiments of the present disclosure.

### DETAILED DESCRIPTION

As indicated above, identical or like reference numbers in the present disclosure may, unless indicated otherwise, indicate identical or like elements, such that repeated description thereof may be omitted for reasons of conciseness.

Particularly, the FIGURES (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Furthermore, in the figures, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the present invention. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths, as may be needed, to affect the communication.

Generally speaking, speech enhancement related processes typically target at removing one or more unwanted artifacts from a noisy waveform and preserving clean speech. Recently, such speech enhancement processes tend to also take advantage of machine learning based techniques, such as deep neural networks (DNN), or the like. It is to be noted that, while the present disclosure may appear to frequently make reference to speech enhancement or the like, it is understood that these merely serve as a possible example of audio processing in general and that the present disclosure shall not be construed as being limited to speech enhancement only.

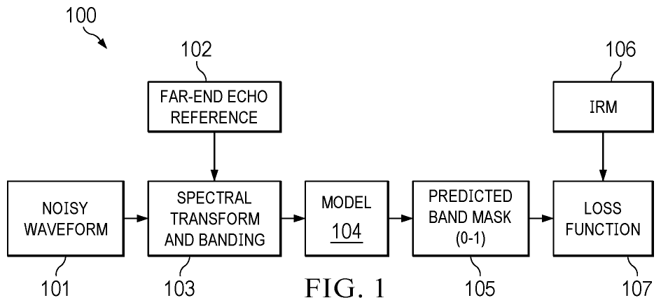

Referring now to FIG. 1 which schematically illustrates a diagram of an example DNN-based audio processing system 100 according to embodiments of the present disclosure. Particularly, a noisy waveform 101, which might be a mixture of clean speech, noise, echo, reverberation, etc., as well as a far-end echo reference signal 102, may be processed by spectral transform and (optionally) banding 103. Subsequently, a DNN 104 may take the mixture band energy as input and attempt to predict a mask for each time-frequency band 105. The mask value is usually between 0 and 1, which generally represents the (estimated/predicted) degree of speech presence in the audio mixture. During the training phase, the DNN model may be exposed to a large dataset of mixtures that may be for example manually created by randomly adding all the signal components, or the like. In some possible implementations, for each sample, an ideal mask might be defined, such as an ideal ratio mask (IRM) 106 according to the above equation (1). Then, the DNN weights would be updated towards minimizing a loss function 107 that generally measures the difference between the predicted and the ideal masks, as may be understood and appreciated by the skilled person.

However, as has already been briefly discussed above, such systems may in some cases experience several potential issues.

First, it may be generally considered quite challenging to collect a large amount of studio-quality clean speech signals. Quite often, the “clean” signals may come with some degree of stationary noise (before adding the additional noises for purposes of the training for the respective audio processing task), such as recording noise, room noise, etc. Therefore, conventional IRM measures are usually larger than they should be, and models trained with such IRM typically cannot remove the associated stationary noise.

Second, in a clean speech signal, there may typically exist some time-frequency band(s) whose energy is/are relatively small (e.g., below a certain threshold). Specifically, omitting these bands may not be perceptually noticeable by end users. With this in mind, it might thus be safe in some possible cases to simply set the IRM values of these bands to 0. For the case of DNN-based training, setting the IRM values to 0 may often be considered to be advantageous as it appears to help to reduce the variability of the targets, making it easier for the model to focus on other more meaningful speech bands. However, an algorithm would be needed to carefully pick a threshold in order to avoid zeroing meaningful speech.

Third, in some possible cases, a speech enhancement DNN may also need to learn (at least implicitly) two behaviors. That is, in a speech region, the DNN may need to attempt to preserve speech and remove noise, usually with a bias towards preserving speech. On the other hand, in a non-speech region, the DNN may need to attempt to aggressively remove unwanted artifacts, with no concern of over-suppressing speech. Therefore, the DNN model may be seen to inherently learn behavior of a voice actively detector (VAD). Therefore, in some possible cases, it may be desirable to incorporate a hand-crafted VAD in the loss function to facilitate the learning as to when to alter the model's aggressiveness (speech frame vs. non-speech frame).

In view thereof, in a broad sense, the present disclosure generally seeks to propose techniques/mechanisms for performing mask thresholding and/or voice activity detection for training DNN-based speech enhancement models.

Before going into detail about possible example embodiments of the present disclosure, it may be worthwhile to first give a brief introduction for the per-channel energy normalization (PCEN) technique, which may be understood as an audio signal processing technique to normalize the energy of each frequency channel in a spectrogram. This may be used in various fields and/or applications, such as for processing front-end features for robust keyword spotting, or the like. In a broad sense, the PCEN-based technique may seek to normalize the energy of each frequency channel in the spectrogram by dividing it by a quantity that is proportional to the average energy of that channel over time. This helps to reduce the effects of background noise and variations in the signal level across different frequency channels.

To be more specific, in some possible implementations, given a band energy spectrogram S(t, f) of a speech signal, for each band f independently (viewed as a function of t), a PCEN measure may be calculated according to the following equation:

$$PCEN ( t , f ) = {( \frac{S ( t , f )}{{( ε + M ( t , f ) )}^{α}} + δ )}^{r} - {δ}^{r} , \qquad ( 2 )$$

where ε=10⁻⁶, α=0.98, δ=2, and r=0.5 (or any other suitable values) are (predetermined) constants, and M(t, f) may be calculated as a running average of S(t, f) according to:

$$M ( t , f ) = ( 1 - s ) \cdot M ( t - 1 , f ) + s \cdot S ( t , f ) , \qquad ( 3 )$$

in which s is a smoothing factor, whose value may be set to 0.2 or the like.

Of course, it is to be noted that the above exemplary calculation of the PCEN measure as defined in equations (2) and (3) are merely provided as illustrative examples, and should in no way be considered as a limitation of any kind. Any other suitable PCEN measure may be implemented and adopted as well, as can be understood and appreciated by the skilled person.

Moreover, it is to be noted that, the algorithms proposed throughout the present disclosure could be applied to either band energies (e.g., as illustrated above) or, if banding is not used in some possible cases, also to bin energies, or the like. In addition, the algorithms proposed throughout the present disclosure could also apply to various suitable transforms (e.g., Fast Fourier Transform (FFT), Modulated Discrete Transform (MDXT), Complex Quadrature Mirror Filter (CQMF), or the like) and banding types.

Now, with reference to the drawings, techniques/mechanisms as proposed in the present disclosure will be discussed in more detail, which may include, but are limited to, PCEN-based mask thresholding and voice activity detection, for improving the mask (e.g., IRM or the like) and the loss function of a mask-based speech enhancement model training.

First of all, techniques related to PCEN-based mask thresholding will be discussed. Particularly, such techniques are proposed to mainly target the above-mentioned first and second issues of the above discussed conventional technologies. As stated above in the first issue, the “clean” speech signal S(t, f) (sometimes may also be understood to represent a ground truth for the training) in the above equations may often come with some sort of stationary noise (e.g., coming from recording devices, recording environment, etc.), which may in some cases cause failure for a DNN that has been trained with IRMs as defined in the above equation (1) to fully remove such stationary noise.

However, it is generally understood that, for each band f (when viewed as a function of t), the speech component may usually change much more rapidly than the stationary noise component would do. As a result, in the computation (e.g., according to the above equations (2) and (3)) of the PCEN measure of the target speech S(t, f) for each band f, the denominator term M(t, f) may be seen to play the role of a low-pass filter due to its smoothing effect.

Furthermore, if the term

$$\frac{S ( t , f )}{{( ε + M ( t , f ) )}^{α}}$$

in equation (2) were to be rewritten as exp(log (S(t,f))−α·log (ε+M(t, f))), the PCEN could then be seen as a high-pass filter in the log energy domain, which would generally subtract out the slowly varying component M(t, f), and presumably, M(t, f), in each band f, contains mainly the stationary noise component.

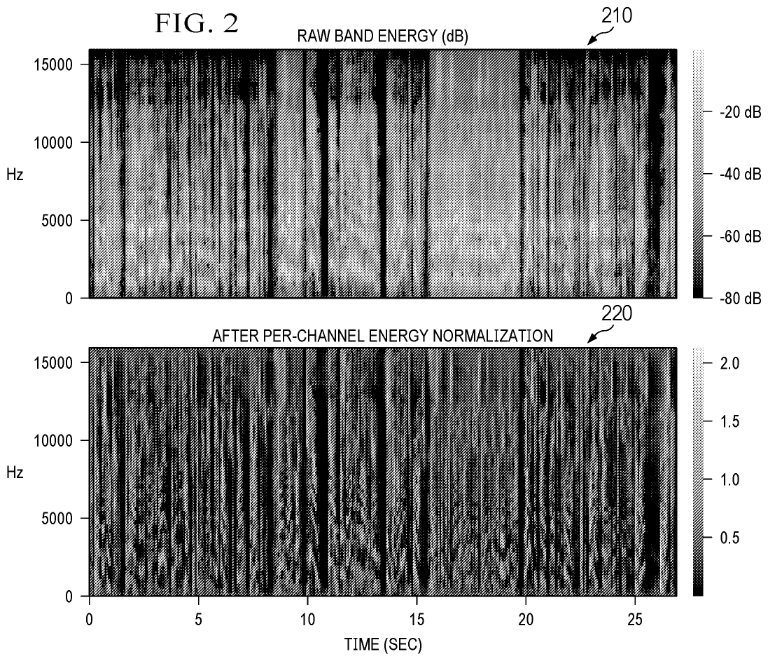

FIG. 2 schematically shows a comparison between an example band energy 210 and its PCEN-based version 220 of a speech signal with stationary noise.

Particularly, in the example of FIG. 2, the band energy before PCEN as shown in the upper graph 210 appears to contain a small degree of stationary noise (e.g., roughly between 15 to 20 seconds). In contrast, as shown in the lower graph 220, after the PCEN process, the stationary noise (between 15 to 20 seconds) appears to be more or less (completely/fully) removed.

It is to be noted that the effect of the high-pass filtering may be understood to be largely controlled by the smoothing factor s in the above equation (3). Specifically, a smaller s may result in more noise removal, but may at the same time also heavily blur the speech harmonics. Therefore, a suitable smoothing factor s may need to be carefully chosen, e.g., based on experiment or simulation, depending on various implementations and/or applications. For instance, in some possible cases, s=0.2 (rather than 0.025 as in conventional technologies) may be observed to yield better results in some applications, empirically.

Although the smoothing factor s may have to be carefully chosen in some cases, it is generally understandable that PCEN may still result in speech loss in some cases (for example as schematically shown in lower graph 220 of FIG. 2).

Therefore, it is noted that techniques proposed in the present disclosure do not use the PCEN-processed speech to define the ideal mask (or in other words, to simply replace S(t, f) in equation (1) by its calculated PCEN version). Instead, the proposed techniques generally use the PCEN-processed speech signal to determine a threshold. Specifically, if the calculated PCEN(t, f) of S(t, f) is smaller than a threshold, it may be an option to simply and directly set IRM(t, f) to 0; and otherwise, the IRM measures may remain the same as defined in equation (1).

By setting the IRMs of the bands with stationary noise to 0, the proposed model may be trained to learn to fully remove such stationary noise, thereby helping solve the above discussed first issue (i.e., relating to the possible stationary noise(s) hidden in the “clean” signal).

Moreover, as stated in the above second issue, omitting the small-energy speech bands by setting their respective IRMs to 0 may help to reduce the variability of the training targets, and accordingly enable the model to focus on meaningful speech bands.

However, as schematically shown in the upper graph 210 in FIG. 2, the speech energy distribution may vary widely as a function of (t, f) (especially as a function of f in some possible cases, as the low-frequency bands are considered to be usually much louder than the high-frequency bands). Thus, using conventional simple methods (such as a global or band-based mean) to determine a threshold without first normalizing the loudness of S(t, f) may likely result in over-suppression of speech (especially in high frequency bands).

In contrast, since the term M(t, f) in the PCEN calculation is generally a smoothed version of S(t, f), the division in the above equation (2) may normalize the loudness of each band. As a consequence, as shown in the lower graph 220 of FIG. 2, the energy dynamic range after PCEN appears to be much narrower, and each band appears to have a somewhat similar level. Therefore, a global constant can act as the threshold for example by generating a histogram of many PCEN-processed speech band energies and picking a small boundary value that won't zero out speech. In some possible implementation settings, a threshold TH_{band}=10⁻⁵ (or the like) may be used. Of course, as can be understood and appreciated by the skilled person, such threshold may be determined (e.g., calculated) in any suitable means, and accordingly, may be set to any suitable value, depending on various implementations and/or applications.

For ease of understanding, the above-proposed PCEN-based mask thresholding algorithm may be summarized as below:

The PCEN-based mask thresholding algorithm:
Given clean speech band energy S(t, f), noise, and other possible
artifacts, do:

Step 1: Compute IRM(t, f) as defined in equation (1).
Step 2: Compute PCEN(t, f) for S(t, f) as defined in equations
(2) and (3), where ε = 10⁻⁶, α = 0.98, δ = 2, r = 0.5 and s =
0.2.
Step 3: For each (t, f), if PCEN(t, f) < TH_{band}, set
IRM(t, f) = 0, where TH_{band} = 10⁻⁵.

It may be worth mentioning that, as can also be understood and appreciated by the skilled person, the above algorithm steps (including the parameters/constants used therein) are merely provided for illustrative purposes, but should not be understood as a limitation of any kind. Of course, the steps and/or the parameters/constants may be suitably adapted, depending on various implementations and/or applications.

Next, techniques related to PCEN-based voice activity detection (VAD) will be discussed. In particular, as discussed above with regard to the third issue, in some possible cases, it may be desirable to aid the model in learning different behaviours in speech and non-speech frames, and/or speech and non-speech bands. Specifically, for speech frames, the loss function may need to be designed to assign a higher priority to preserving speech than removing noise; whereas in non-speech frames, noise (and possibly also other unwanted artifacts, such as echo or the like) may need to be suppressed as aggressively as possible. As a result, in order to achieve such speech-aware training, a VAD and optionally also a loss function guided by the VAD may be needed. As may be understood and appreciated by the skilled person, any suitable (existing or new) VAD technique may be used and integrated into the speech-aware loss implementation. For instance, an illustrative (non-limiting) example of an existing VAD technique may be the conventional WebRTC VAD technique.

In some possible implementations, a simple PCEN-based VAD may be built on top of the above-proposed band level PCEN threshold. Namely, given the target speech S(t, f), for each frame t, the system may be configured to first compute the frame energy, for example as the sum of the band energies in that frame. Subsequently, in some possible examples, the system may be configured to set the speech/non-speech frame-level (or frame-wise) threshold empirically as:

$$T {H}_{frame} \approx T {H}_{b a n d} \cdot N , \qquad ( 4 )$$

where TH_{band} may be the previously defined band-level PCEN speech threshold, and N may be the number of bands in each frame. For instance, in some possible implementations, TH_{frame}=0.0005 may be set based on for example N=56 bands in our system multiplying TH_{band}=10⁻⁵. Of course, similar to the above-illustrated PCEN based thresholding, it is also to be noted that the above exemplary calculation of the frame-level threshold as defined in equation (4) is merely provided as an illustrative example, and should in no way be considered as a limitation of any kind. Any other suitable implementation may be adopted as well, as can be understood and appreciated by the skilled person.

Accordingly, if the frame energy falls below this frame-wise threshold, this frame may be empirically classified as a non-speech frame; and as a result, the IRM values of all the bands in this frame may be set to 0, which may be understood to be able to further reduce the variability in the training targets.

Furthermore, in some possible implementations, a loss function that is to be used in training the DNN model may be designed to penalize over-suppression of speech more than insufficient noise removal. As an illustrative (non-limiting) example, the loss function (defined for each time-frequency band, which is however omitted in the equations below) may be defined as:

$$loss = {a}^{diff} - d i f f - 1 , \qquad ( 5 )$$

where, in some possible cases, diff may be understood to represent the difference between the IRM and the estimated mask maskₑₛₜ from the DNN as:

$$diff = {IRM}^{γ} - {mask}_{e s t}^{γ} , \qquad ( 6 )$$

in which α=2.7 and γ=0.5 (or any other suitable value) may be empirically determined.

In some possible implementations, both the IRM and the estimated masks as proposed in the above equations (5) and (6) may be converted using a power-law to a perceptual scale; and accordingly, the loss may be seen as an exponential function of their difference.

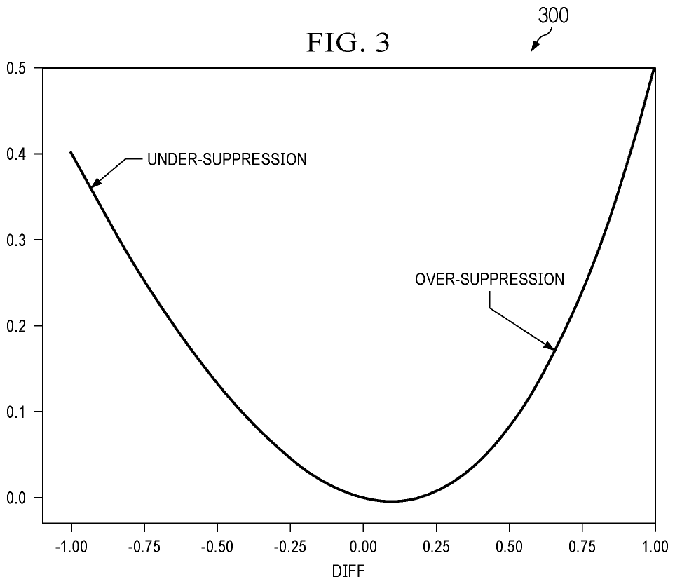

FIG. 3 schematically shows a graph 300 plotting an example implementation of this loss as a function of diff. Generally speaking, the loss function in the shown example implementation is designed to penalize over-suppression of speech more than under-suppression of noise by larger gradient values.

Particularly, in the example graph 300, on the positive side (i.e., where diff >0), which corresponds to over-suppression of speech by the model (since IRM is greater than the predicted mask according to the above equation (6)), the loss function is steeper, having a larger gradient (larger slope) than on the negative side (i.e., where diff<0), where under-suppression of noise happens. Since gradient descent related techniques are generally used to minimize the loss by back propagating this gradient through all the model weights, the model weights would be updated faster from the over-suppression side towards the optimal point than from the other side.

However, this loss function appears to not differentiate speech from non-speech frames. To be more specific, in non-speech frames (e.g., estimated by the PCEN-VAD or any other suitable VAD process), since the IRMs are set to 0 as proposed above, over-suppression of speech usually would not happen (since the predicted masks, which are typically implemented by a sigmoid function in the last layer of the model, are usually greater than 0). Therefore, in some possible implementations, it may be proposed to use a larger gradient to aggressively suppress noise in these (non-speech) frames. For instance, in some possible examples, this larger gradient may be achieved by simply flipping (reversing) the order of the two terms in the above diff function defined in equation (6) as:

$${diff}_{nonspeech} = {mask}_{est}^{γ} - {IRM}^{γ} = {mask}_{est}^{γ} , \qquad ( 7 )$$

since IRM measures have been (intentionally) set to 0, as proposed above.

Because diff_{nonspeech} would always be on the positive side of the loss function (see graph 300 of FIG. 3), the (new) loss function will have a larger gradient, compared with the original diff in equation (6), in which that diff in equation (6) is negative and would thus have a smaller gradient.

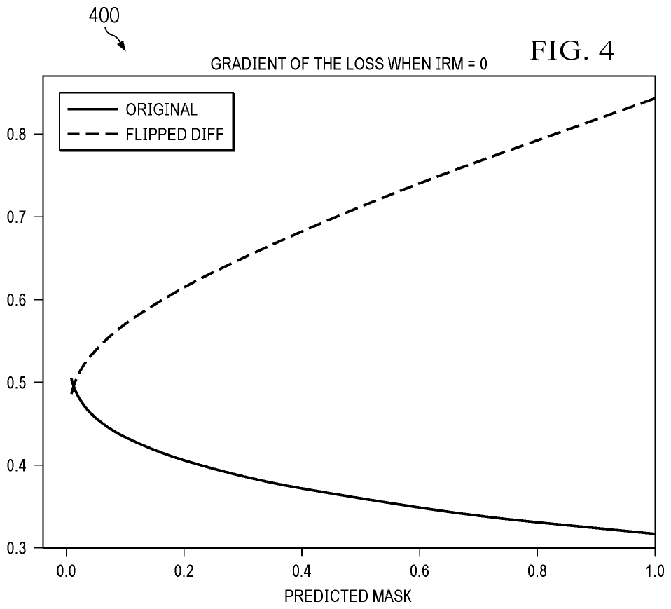

FIG. 4 schematically shows a graph 400 plotting the gradient of the newly proposed loss function with respect to the predicted mask for the non-speech frames (where IRMs have been set to 0 by the above-proposed PCEN-VAD process), from which it could be seen that the larger gradient (compared to that of FIG. 3) is enabled simply by flipping the diff's sign. This way, the predicted masks will be driven aggressively towards 0 to remove unwanted artifacts in the non-speech frames.

However, it is to be noted that, as can be understood and appreciated by the skilled person, such an approach of flipping the sign of the diff is merely provided as an illustrative example. Any other suitable mechanism for example for increasing the gradient may be considered, depending on various implementations and/or applications. For instance, different values for α and γ in the above equations (5)-(7) may be used for the calculation of speech and non-speech regions, respectively. For example, for speech frames, α_{speech}=2.7 and γ_{speech}=0.5 or the like may be used, which may provide a tradeoff between speech preservation and noise suppression. On the other hand, for non-speech frames, α_{nonspeech} 2.7 and γ_{nonspeech} <0.5 or the like may be used instead, since a larger α and smaller γ in the loss function of non-speech frames may typically provide a larger gradient to remove noise more aggressively. Of course, these examples, including the mentioned values are not to be understood as a limitation of any kind.

Similar to above, the proposed algorithm for the PCEN-based VAD and the speech-aware loos function may be summarized as below:

The PCEN-based VAD and speech-aware loss function:
Given clean speech band energy S(t, f), noise, and other possible
artifacts, do:

Step 1: Compute IRM(t, f) as defined in equation (1).
Step 2: Compute PCEN(t, f) for S(t, f) as defined in equations
(2) and (3), where ε = 10⁻⁶, α = 0.98, δ = 2, r = 0.5 and s =
0.2.
Step 3: For each frame t, compute the frame energy as E(t) =
Σ_{f} PCEN(t, f), and set PCEN_VAD(t) = 1 if E(t) > TH_{frame}
(speech frame) and 0 (non-speech frame) otherwise.
Step 4: For each frame t, set IRM(t, f) for all bands f to 0 if
PCEN_VAD(t) = 0.
Step 5: Compute diff_{speech} = IRM^{γ} − maskₑₛₜ^{γ} and
diff_{nonspeech} = maskₑₛₜ^{γ} − IRM^{γ} = maskₑₛₜ^{γ} for speech and
non-speech frames respective.
Step 6: Compute loss using equation (5) for speech and non-
speech frames, and average the loss of all (t, f) bands to get the
final loss.

It may be worth mentioning that, as can also be understood and appreciated by the skilled person, the above algorithm steps (including the parameters/constants used therein) are merely provided for illustrative purposes, but should not be understood as a limitation of any kind. Of course, the steps and/or the parameters/constants may be suitably adapted, depending on various implementations and/or applications.

For instance, the general idea of VAD-controlled loss function could be further extended beyond the specific loss function as described above. That is, other suitable loss functions could be made to be less or more aggressive in speech vs. non-speech regions, for example based on the VAD value. In some possible implementations, the VAD-based loss function may use temporal information for different processing strategies of pure noise segments. Specifically, because of the sparse characteristic of speech signals in general, even during speech presence segments, there may also be pure noise in some possible bands.

Accordingly, in some implementations, it may be possible to use for example sub-band speech presence probability estimation in the loss function during training. The VAD-controlled loss function as described above could then be extended to sub-band speech-presence-probability-controlled loss function. In such cases, any suitable (existing or new) speech presence probability (SPP) estimation method or mechanism may be used in the loss function implementation. As an illustrative example of this generalization, the sign-flipped loss definition as described in the above equation (7) may be applied not only to the non-speech frames (e.g., determined by the PCEN-VAD), but also to non-speech bands (e.g., determined by the band level PCEN-threshold) in speech frames.

Furthermore, in some possible implementations, it may be possible to either use only one of the algorithms/techniques (i.e., PCEN-based mask thresholding, PCEN-based VAD, speech-aware loss function), or more at the same time in practice.

For instance, in some possible cases when all the above-proposed techniques are used, the PCEN mask thresholding may be run first to set the IRMs of non-speech bands to 0 (but those frames could be speech frames). Next, the PCEN-based VAD may be conducted to set the IRMs of non-speech frames to 0. It is to be noted that, in both algorithms, the input to PCEN is the original clean speech S(t, f). Further, in some possible cases, the same PCEN parameters may be used, and as a result, the PCEN measure may be computed only once. Of course, in some other possible cases, different PCEN parameters for the band-level speech/non-speech decision as opposed to the frame-level one could potentially be used as well. Finally, the speech-aware loss may be minimized by updating the model weights. It may be empirically understood that using all the above-proposed techniques/algorithms would achieve the best performance, resulting in more noise and (especially) echo being removed, compared with using only one of the techniques/algorithms.

It is to be noted that, generally speaking, any suitable DNN that is used to predict IRMs, regardless of its architecture, could benefit from the algorithms proposed throughout the present disclosure, which could be used to for example improve the IRM and the loss function implementations for training such models.

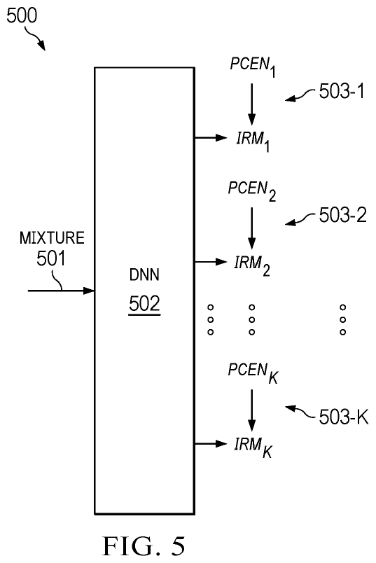

For instance, in some possible implementations, the proposed PCEN-threshold and PCEN-VAD techniques may be extended to train multitask models. FIG. 5 is a schematic illustration showing a diagram of such an example DNN 500 configured for training multi-task models according to embodiments of the present disclosure.

In particular, as depicted in FIG. 5, a model 502 may be trained to, taking the audio mixture 501 as input, predict K sets of IRMs 503-1, 503-2, . . . , 503-K. For instance, one IRM (e.g., 503-1) might be defined to remove any artifacts (such as noise, reverberation, echo, etc.), another IRM (e.g., 503-2) might not remove reverberation (in this case S(t, f) would be reverberant speech), and a third IRM (e.g., 503-K) might target at preserving music or speech (in this case S(t, f) would be either music or speech). Accordingly, one or more PCEN thresholds and PCEN-VADs could be applied to one or more sets of IRMs. That is to say, the PCEN-based techniques may be, but do not necessarily have to be, applied to some (or all) of the IRM tasks.

As mentioned earlier, the algorithms proposed throughout the present disclosure could be applied to either band energies (e.g., as illustrated above) or, if banding is not used in some possible cases, also to bin energies, or the like. In addition, the algorithms proposed throughout the present disclosure could also apply to various suitable transforms (e.g., MDXT, CQMF, or the like) and banding types.

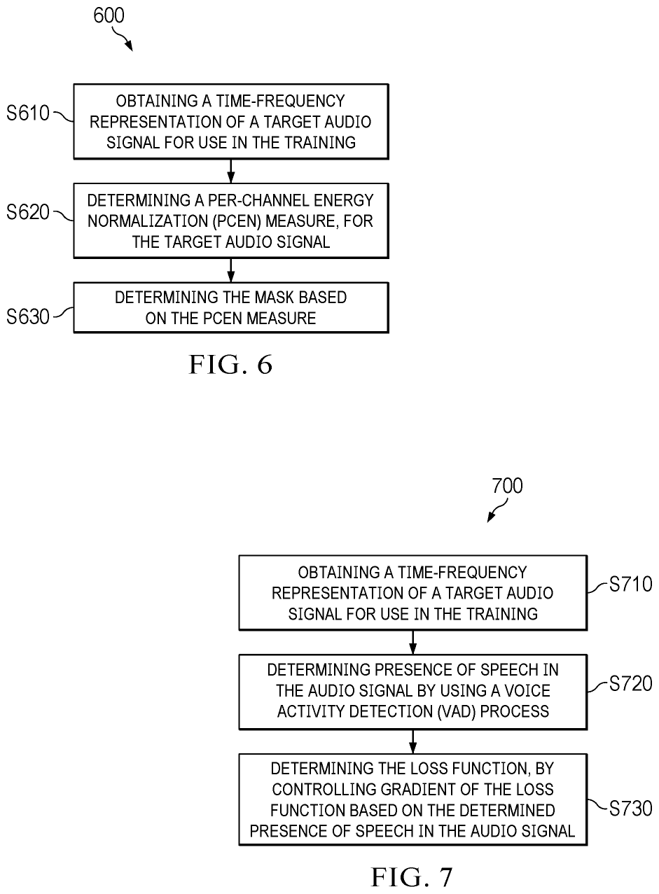

FIG. 6 is a schematic flowchart illustrating an example of a method 600 of determining at least one mask (e.g., one or more masks) for use in training a DNN-based mask-based audio processing model according to embodiments of the present disclosure. As noted earlier, the model may be trained for performing any suitable audio related processing, such as (but is certainly not limited to) speech enhancement (e.g., de-nosing, removing artifacts, etc.), or the like. As can also be understood and appreciated by the skilled person, any suitable DNN (or more generally, neural network) implementation may be used, regardless of the actual architecture, depending on various implementations and/or applications.

In particular, the method 600 as shown in FIG. 6 may start at step S610 by obtaining a time-frequency representation of a target audio signal for use in the training. In general, particularly within the technical context of the present disclosure, the term “target audio signal” is typically used to refer to the audio signal that the DNN-based model is trained to target for, in order to perform the respective audio processing, unless indicated otherwise. As an illustrative (non-limiting) example for ease of understanding, in some cases where the model is trained for preserving only clean audio signals from a noisy audio mixture (e.g., by removing all unwanted artifacts), the target audio signal may then be clean audio (e.g., speech) signals (e.g., collected by professionals). In some other cases where the model is trained for not removing reverberation (but removing all other artifacts) from a noisy audio mixture, the target audio signal may then be reverberant audio signals (i.e., with reverberation).

Subsequently, at step S620 the method 600 may comprise determining a PCEN measure for the target audio signal. As will be discussed in more detail below, PCEN may be seen as an audio signal processing technique to normalize the energy of each frequency channel in a spectrogram. In a broad sense, the PCEN-based technique may seek to normalize the energy of each frequency channel in the spectrogram by dividing it by a quantity that is proportional to the average energy of that channel over time. This helps to reduce the effects of background noise and variations in the signal level across different frequency channels.

Accordingly, the method 600 may yet further comprise at step S630 determining the mask based on the PCEN measure.

Configured as proposed above, the proposed method may generally provide an efficient, flexible yet reliable mechanism for determining the mask that may be later used in training the DNN-based audio processing (e.g., speech enhancement) model. Specifically, as noted above, “clean” speech signals collected for training (e.g., S(t, f) in the above equation (1)) often come with some degree of stationary noises, which might cause failure for a DNN trained with conventional IRMs to be able to successfully and fully remove such stationary noises. Now, particularly by the introduction of the PCEN measure in the process as proposed above, the mask(s) may be determined in such a manner that also those stationary noises (which are typically embedded in the “clean” signals) could be largely (or even completely in some cases) removed, thereby significantly improving the performance of the subsequent training process, and in turn, also significantly improving the final performance in real practice (i.e., after the model has been trained). Incidentally, it is also to be noted that, compared to conventional techniques, the PCEN measure as proposed in the present disclosure is generally used only in the training stage but not at testing time.

FIG. 7 is a schematic flowchart illustrating an example of a method 700 of determining a speech-aware loss function for use in training a DNN-based mask-based audio processing model according to embodiments of the present disclosure.

In particular, the method 700 as shown in FIG. 7 may start at step S710 by obtaining a time-frequency representation of a target audio signal for use in the training. Subsequently, at step S720 the method 700 may comprise determining presence of speech in the audio signal by using a VAD process. As may be understood and appreciated by the skilled person, any suitable (existing or new) VAD technique may be used. Finally, the method 700 may yet further comprise at step S730 determining the loss function based on the determined presence of speech in the target audio signal. Particularly, as can be understood and appreciated by the skilled person, gradient descent is typically used to minimize the loss by back propagating this gradient through all the model weights. Accordingly, the determination of the loss function may be achieved by controlling the gradient of the loss function based on the determined presence of speech in the target audio signal.

Configured as proposed above, the proposed method may generally provide an efficient, flexible yet reliable mechanism for determining the loss function that may be later used in training the DNN-based audio processing (e.g., speech enhancement) model. Specifically, according to the techniques proposed above, the loss function may be determined in such a manner that is designed to assign a higher priority to preserving speech than removing noise (in speech frames); whereas in non-speech frames, noise (and other unwanted artifacts, such as echo or the like) might be suppressed as aggressively as possible. Thereby, the performance of the training process may be significantly improved, and in turn, the final performance in real practice (i.e., after the model has been trained) may also be significantly improved.

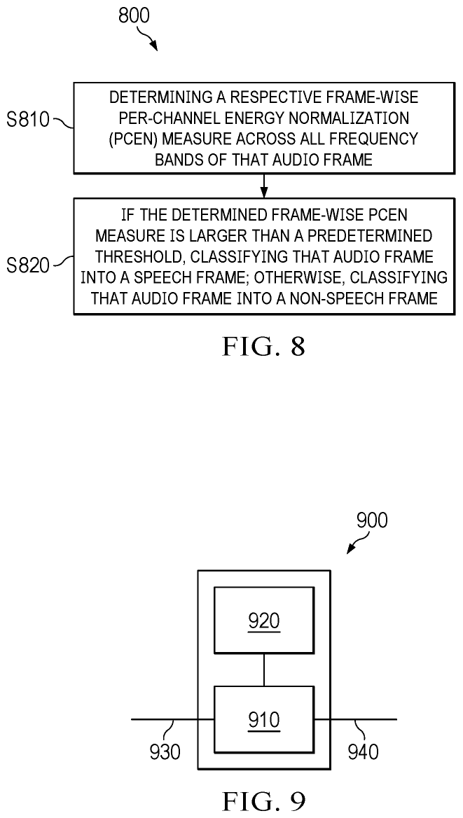

FIG. 8 is a schematic flowchart illustrating an example of a method 800 of classifying a target audio signal into speech frames or non-speech frames according to embodiments of the present disclosure.

In particular, the method 800 as shown in FIG. 8 may start at step S810 by determining, for each audio frame of the target audio signal, a respective frame-wise PCEN measure across all frequency bands of that audio frame. Subsequently, at step S820 the method 800 may comprise if the determined frame-wise PCEN measure is larger than a predetermined threshold, classifying that audio frame into a speech frame; otherwise, classifying that audio frame into a non-speech frame.

Finally, the present disclosure likewise relates to apparatus for performing methods and techniques described throughout the present disclosure. FIG. 9 generally shows an example of such apparatus 900. In particular, apparatus 900 comprises a processor 910 and a memory 920 coupled to the processor 910. The memory 920 may store instructions for the processor 910. The processor 910 may also receive, among others, suitable input data 930 (e.g., audio signals), depending on various use cases and/or implementations. The processor 910 may be adapted to carry out the methods/techniques (e.g., any of methods 600, 700, 800 as illustrated above with reference to FIGS. 6 to 8) described throughout the present disclosure and to generate correspondingly output data 940 (e.g., mask, loss function, etc.), depending on various use cases and/or implementations.

### Interpretation

A computing device implementing the techniques described above can have the following example architecture. Other architectures are possible, including architectures with more or fewer components. In some implementations, the example architecture includes one or more processors (e.g., dual-core Intel® Xeon® Processors), one or more output devices (e.g., LCD), one or more network interfaces, one or more input devices (e.g., mouse, keyboard, touch-sensitive display) and one or more computer-readable mediums (e.g., RAM, ROM, SDRAM, hard disk, optical disk, flash memory, etc.). These components can exchange communications and data over one or more communication channels (e.g., buses), which can utilize various hardware and software for facilitating the transfer of data and control signals between components.

The term “computer-readable medium” refers to a medium that participates in providing instructions to processor for execution, including without limitation, non-volatile media (e.g., optical or magnetic disks), volatile media (e.g., memory) and transmission media. Transmission media includes, without limitation, coaxial cables, copper wire and fiber optics. Computer-readable medium can further include operating system (e.g., a Linux® operating system), network communication module, audio interface manager, audio processing manager and live content distributor. Operating system can be multi-user, multiprocessing, multitasking, multithreading, real time, etc. Operating system performs basic tasks, including but not limited to: recognizing input from and providing output to network interfaces and/or devices; keeping track and managing files and directories on computer-readable mediums (e.g., memory or a storage device); controlling peripheral devices; and managing traffic on the one or more communication channels. Network communications module includes various components for establishing and maintaining network connections (e.g., software for implementing communication protocols, such as TCP/IP, HTTP, etc.).

Architecture can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Unless specifically stated otherwise, as apparent from the following discussions, it is appreciated that throughout the present invention discussions utilizing terms such as “processing”, “computing”, “calculating”, “determining”, “analyzing” or the like, refer to the action and/or processes of a computer or computing system, or similar electronic computing devices, that manipulate and/or transform data represented as physical, such as electronic, quantities into other data similarly represented as physical quantities.

Reference throughout this invention to “one example embodiment”, “some example embodiments” or “an example embodiment” means that a particular feature, structure or characteristic described in connection with the example embodiment is included in at least one example embodiment of the present invention. Thus, appearances of the phrases “in one example embodiment”, “in some example embodiments” or “in an example embodiment” in various places throughout this invention are not necessarily all referring to the same example embodiment. Furthermore, the particular features, structures or characteristics may be combined in any suitable manner, as would be apparent to one of ordinary skill in the art from this invention, in one or more example embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the present invention, various features of the present invention are sometimes grouped together in a single example embodiment, FIG., or description thereof for the purpose of streamlining the present invention and aiding in the understanding of one or more of the various inventive aspects. This method of invention, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this invention.

Furthermore, while some example embodiments described herein include some but not other features included in other example embodiments, combinations of features of different example embodiments are meant to be within the scope of the present invention, and form different example embodiments, as would be understood by those skilled in the art. For example, in the following claims, any of the claimed example embodiments can be used in any combination.

In the description provided herein, numerous specific details are set forth. However, it is understood that example embodiments of the present invention may be practiced without these specific details. In other instances, well-known methods, structures and techniques have not been shown in detail in order not to obscure an understanding of this description.

Thus, while there has been described what are believed to be the best modes of the present invention, those skilled in the art will recognize that other and further modifications may be made thereto without departing from the spirit of the present invention, and it is intended to claim all such changes and modifications as fall within the scope of the present invention. For example, any formulas given above are merely representative of procedures that may be used. Functionality may be added or deleted from the block diagrams and operations may be interchanged among functional blocks. Steps may be added or deleted to methods described within the scope of the present disclosure.

Enumerated example embodiments (“EEEs”) of the present disclosure have been described above in relation to methods and systems for determining an indication of an audio quality of an audio input. Thus, an embodiment of the present invention may relate to one or more of the examples, enumerated below:
EEE 1. Training a speech enhancement network with PCEN-based mask thresholding for the target.
EEE 2. Training a speech enhancement network using a VAD (such as the proposed PCEN-VAD) to control the aggressiveness of the loss function.
EEE 3. A specific speech-aware loss function that incorporates the VAD information and controls the aggressiveness of the loss in speech/non-speech frames by flipping the sign of the predicted error.
EEE 4. A method of processing audio comprising:
   training a neural network with per-channel energy normalization (PCEN) based mask thresholding for a target;
   controlling aggressiveness of loss function of the neural network using voice activity detection (VAD);
   determining a loss function for the neural network based on an ideal ratio mask (IRM) and an estimated mask from the neural network; and
   providing the trained neural network for speech enhancement.
EEE 5. The method of EEE 4, wherein the VAD includes at least one of a frame-level decision or a band-based speech presence probability.
EEE 6. The method of any of EEE 4 or 5, comprising training a multitask model to predict a plurality of IRMs, each of the IRMs corresponding to a respective aspect of the speech enhancement.
EEE 7. The method of any of EEEs 4 to 6, wherein the plurality of IRMs includes at least one of:
   a first IRM configured to remove artifacts including reverberation;
   a second IRM configured to remove artifacts except reverberation; or
   a third IRM configured to preserve music and speech.
EEE 8. A method of processing audio, comprising:
   training a neural network with per-channel energy normalization (PCEN) based mask thresholding for a target; and
   providing the trained neural network for speech enhancement.
EEE 9. The method of any of EEEs 4 to 8, wherein training the neural network comprises:
   computing, for each time-frequency band, a respective ideal ratio mask (IRM) based on time-frequency band energy for clean speech, time-frequency band energy for noise and time-frequency band energy for echo;
   computing, for each time-frequency band, a respective PCEN filter based on the time-frequency band energy for clean speech; and
   adjusting, for each time-frequency band, the respective IRM if the corresponding PCEN filter for that time-frequency band satisfies a PCEN threshold.
EEE 10. A method of processing audio, comprising:
   training a neural network, including controlling aggressiveness of a loss function of the neural network using voice activity detection (VAD); and
   providing the trained neural network for speech enhancement.
EEE 11. The method of any of EEEs 4 to 10, wherein the VAD is a per-channel energy normalization (PCEN) based VAD, wherein the PCEN-based VAD operates by performing steps comprising:
   computing, for each frame, a respective frame energy based on speech energies across frequency bands of the each frame; and
   classifying each frame as speech or non-speech based on whether the respective frame energy satisfies a PCEN speech threshold.
EEE 12. The method of any of EEEs 4 to 11, wherein the loss function, controlled by the VAD, includes a sub-band speech presence-probability-controlled loss function.
EEE 13. The method of any of EEEs 4 to 12, wherein the loss function includes a speech presence probability (SPP) estimation function.
EEE 14. A method of processing audio, comprising:
   determining a loss function for a neural network based on an ideal ratio mask (IRM) and an estimated mask from the neural network, wherein the loss function is formulated
   differently for speech and non-speech frames or bands; and providing the trained neural network for speech enhancement.
EEE 15. A system including one or more processors configured to perform operations of any one of EEEs 4 to 14.
EEE 16. A computer program product configured to cause one or more processors to perform operations of any one of EEEs 4 to 14.

The invention claimed is:

1. A method of determining at least one mask for use in training a deep neural network, DNN, -based mask-based audio processing model, the method comprising:
obtaining a time-frequency representation of a target audio signal for use in the training;
determining a per-channel energy normalization, PCEN, measure for the target audio signal; and
determining the at least one mask based on the PCEN measure.

2. The method according to claim 1, wherein the target audio signal comprises speech and/or music.

3. The method according to claim 1, wherein the target audio signal is for use as a ground truth for the training.

4. The method according to claim 1, wherein the target audio signal comprises a clean audio component, and a stationary noise component such as recording noise and/or room noise.

5. The method according to claim 1, wherein the PCEN measure is determined based on a ratio of a time-frequency energy measure of the target audio signal and a running average of the time-frequency energy measure of the target audio signal.

6. The method according to claim 1, wherein the method further comprises:
obtaining an audio mixture based on the target audio signal, wherein the audio mixture comprises, in addition to the target audio signal, audio artifacts; and
wherein the determination of the at least one mask based on the PCEN measure involves:
determining at least one ideal ratio mask, IRM, measure based on the target audio signal and the audio mixture; and
adjusting the at least one IRM measure to obtain the at least one mask based on the PCEN measure.

7. The method according to claim 6, wherein the audio artifacts comprises at least one of: noise, echo, or reverberation.

8. The method according to claim 6, wherein the IRM measure is determined as a ratio of a time-frequency energy measure of the target audio signal to a time-frequency energy measure of the audio mixture including the audio artifacts.

9. The method according to claim 6, wherein respective values of the PCEN and the IRM measures are determined for each time-frequency band of the target audio signal; and
wherein the adjustment of the IRM measure involves:
for each time-frequency band, setting the respective IRM measure value for that time-frequency band to 0, if the respective PCEN measure value is less than a first predetermined threshold.

10. The method according to claim 1, wherein the method further comprises:
classifying the target audio signal into speech frames or non-speech frames; and
for each audio frame, determining the at least one mask further based on a classification of speech frames or non-speech frames.

11. The method according to claim 10, wherein the classification of the target audio signal into speech frames or non-speech frames involves, for each audio frame of the target audio signal:
determining a respective frame-wise PCEN measure across all frequency bands of that audio frame; and
if the determined frame-wise PCEN measure is larger than a second predetermined threshold, classifying that audio frame into a speech frame; otherwise, classifying that audio frame into a non-speech frame.

12. (canceled)

13. The method according to claim 1, wherein the PCEN measure is determined according to, for each time-frequency band:
$$PCEN ( t , f ) = {( \frac{S ( t , f )}{{( ε + M ( t , f ) )}^{α}} + δ )}^{r} - {δ}^{r} ,$$
wherein S(t, f) is a time-frequency energy of the target audio signal, ε, α, δ, and r are predetermined constants, and M(t, f) is a running average of S(t, f) defined as:
$$M ( t , f ) = ( 1 - s ) \cdot M ( t - 1 , f ) + s \cdot S ( t , f ) ,$$
in which s is a predetermined smoothing factor.

14. The method according to claim 1, wherein the DNN-based mask-based audio processing model is a multitask model configured for being trained for predicting a plurality of masks each corresponding to a respective audio processing aspect, and wherein the method involves:
obtaining a respective target audio signal for each audio processing aspect;
determining a respective PCEN measure for each target audio signal; and
determining a respective mask based on the PCEN measure.

15. A method of determining a speech-aware loss function for use in training a deep neural network, DNN, -based audio processing model, the method comprising:
obtaining a time-frequency representation of a target audio signal for use in the training;
determining presence of speech in the target audio signal by using a voice activity detection, VAD, process; and
determining the loss function, by controlling gradient of the loss function based on the determined presence of speech in the target audio signal.

16. The method according to claim 15, wherein the VAD process involves:
determining frame-wise and/or band-wise presence of speech in the target audio signal; and
wherein the controlling of the gradient of the loss function based on the determined presence of speech in the target audio signal involves:
increasing the respective gradient of the loss function for a non-speech frame and/or band such that audio artifacts are suppressed more aggressively in the non-speech frame and/or band.

17. The method according to claim 16, wherein the determination of the frame-wise presence of speech in the target audio signal involves, for each audio frame of the target audio signal:
determining a frame-wise per-channel energy normalization, PCEN, measure across all frequency bands of the respective audio frame; and
if the determined frame-wise PCEN measure is larger than a predetermined threshold, determining that the respective audio frame contains speech.

18. The method according to claim 16, wherein the determination of the band-wise presence of speech in the target audio signal involves, for each speech frame of the target audio signal:
determining a respective band-wise PCEN measure for each frequency band of that speech frame; and
if the determined band-wise PCEN measure is less than a second predetermined threshold, determining the respective frequency band of that speech frame as a non-speech band.

19. The method according to claim 15, wherein the loss function is determined such that over-suppression of speech is penalized more than under-suppression of noise in the target audio signal.

20. The method according to claim 15, wherein the loss function loss is defined as, for each time-frequency band:
$$loss = {a}^{diff} - d i f f - 1 ,$$
where α is a predetermined constant, and diff indicates a difference between an ideal ratio mask, IRM, measure determined for the target audio signal and an estimated mask maskₑₛₜ predicted by the DNN-based audio processing model.

21. The method according to claim 20, wherein the diff is defined as, for a speech frame:
$$diff = {IRM}^{γ} - {mask}_{e s t}^{γ} ;$$
and
for a non-speech frame:
diff=maskₑₛₜ^{γ}
in which γ is a predetermined constant.

22. (canceled)

23. The method according to claim 15, wherein the determination of the loss function involves:
determining respective loss function for speech and non-speech frames; and
averaging the loss function for all time-frequency bands, thereby obtaining a final loss function.

24. (canceled)

25. A method of classifying a target audio signal into speech frames or non-speech frames, the method comprising, for each audio frame of the target audio signal:
determining a respective frame-wise per-channel energy normalization, PCEN, measure across all frequency bands of that audio frame; and
if the determined frame-wise PCEN measure is larger than a predetermined threshold, classifying that audio frame into a speech frame; otherwise, classifying that audio frame into a non-speech frame.

26-28. (canceled)
